(19) United States
(12) Patent Application Publication
(10) Pub. No.: US 2020/0050048 A1
(43) Pub. Date: Feb. 13, 2020

(54) DISPLAY DEVICE

(71) Applicant: SHARP KABUSHIKI KAISHA, Sakai City (JP)

(72) Inventors: SHIGENORI MORIOKA, Sakai City (JP); KENICHI SANUKI, Sakai City (JP)

(21) Appl. No.: 16/530,412

(22) Filed: Aug. 2, 2019

(30) Foreign Application Priority Data
Aug. 7, 2018 (JP) 2018-148600

(51) Int. Cl. G02F 1/1333; G02F 1/1335; G02F 1/13357; G02F 1/1343; G02F 1/1362; H04N 5/225

(52) U.S. Cl. CPC G02F 1/133308; G02F 1/133528; G02F 1/1336; G02F 1/1368; G02F 1/136209; H04N 5/2257; G02F 2202/28; G02F 1/1343

(57) ABSTRACT

According to a display device, a space for light transmission is formed in each of a first polarizing plate, a second polarizing plate, and a backlight so that light from an outside of the display device enters an image capturing device, a liquid crystal panel and the image capturing device being provided on opposite sides of the backlight.

This Nonprovisional application claims priority under U.S.C. § 119 on Patent Application No. 2018-148600 filed in Japan on Aug. 7, 2018, the entire contents of which are hereby incorporated by reference.

### TECHNICAL FIELD

The present invention relates to a display device.

### BACKGROUND ART

A display device has been recently known as a conventional technique, in which display device an image capturing device, for example is provided in a display screen so that the display device has a narrower frame. Such a display device is exemplified by a display device disclosed in Patent Literature 1. The display device, disclosed in Patent Literature 1, includes a light transmissive display screen on which back surface side one or more sensors are provided so as to sense light which has entered the display device through the display screen. The display device, disclosed in Patent Literature 1, is configured so that the one or more sensors are put into the shade in a case where the display device is viewed from the front surface side of the display screen.

### CITATION LIST

### Patent Literature

[Patent Literature 1]

Japanese Patent Application Publication Tokukai No. 2012-70356

### SUMMARY OF INVENTION

### Technical Problem

The display device, disclosed in Patent Literature 1, is arranged by use of a transparent organic electroluminescence (EL) panel. In contrast, in a case where a display device is arranged by use of a liquid crystal panel, a space for light transmission needs to be formed in a backlight of the display device, in order for an image capturing device to be provided in the display screen.

A display device, in which an image capturing device is provided in a display screen and (which is arranged by use of a liquid crystal panel, is exemplified by a display device 100 (see FIG. 4). FIG. 4 is a cross-sectional view illustrating an arrangement of a cross section of the display device 100, which is a conventional display device. The display device 100 includes a backlight 20b, a liquid crystal panel 30b, and an adhesive layer 40b in each of which a space is formed. In the space, an image capturing device 10b is provided. The liquid crystal panel 30b includes a first polarizing plate 31b, a liquid crystal panel glass part 32b, and a second polarizing plate 33b.

As illustrated in FIG. 4, according to the display device 100, a print layer PLb is provided so as to (i) face in a direction in which the liquid crystal panel 30b and the backlight 20b are provided in this order and (cover an outer circumferential part of the space. Furthermore, the print layer PLb is provided so as to cover an outer circumferential part of the image capturing device 10b while avoiding a range R1 of angle of view of the image capturing device lob. The print layer PLb which thus covers the outer circumferential part of the image capturing device 10b has a greater size. This results in failure to achieve excellence in design of the display device 100.

An aspect of the present invention has an object to make a display device more excellent in design while maintaining performance of an image capturing device.

### Solution to Problem

In order to attain the object, a display device in accordance with an aspect of the present invention includes: a backlight; and a liquid crystal panel provided on the backlight, the liquid crystal panel including a first polarizing plate, a second polarizing plate, and a liquid crystal panel glass part which is provided so as to be sandwiched between the first polarizing plate and the second polarizing plate, a space for light transmission being formed in each of the first polarizing plate, the second polarizing plate, and the backlight so that light from an outside of the display device enters an image capturing device, the liquid crystal panel and the image capturing device being provided on opposite sides of the backlight.

### Advantageous Effects of Invention

An aspect of the present invention makes it possible to make a display device more excellent in design while maintaining performance of an image capturing device.

### BRIEF DESCRIPTION OF DRAWINGS

FIG. 1 is a cross-sectional view illustrating an arrangement of a cross section of a display device in accordance with Embodiment 1 of the present invention.

FIG. 2 is an enlarged view of a part of the display device illustrated in FIG. 1, the part being provided with a space.

FIG. 3 is a cross-sectional view illustrating an arrangement of a cross section of a display device in accordance with Embodiment 2 of the present invention.

FIG. 4 is a cross-sectional view illustrating an arrangement of a cross section of a conventional display device.

### DESCRIPTION OF EMBODIMENTS

Embodiment 1

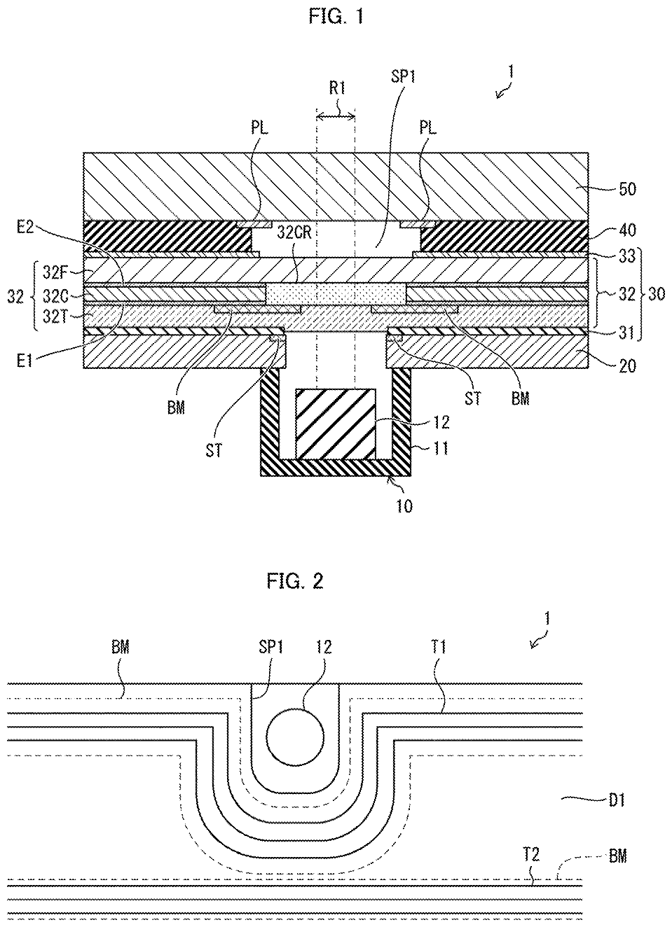

FIG. 1 is a cross-sectional view illustrating an arrangement of a cross section of a display device I in accordance with Embodiment 1 of the present invention. FIG. 2 is an enlarged view of a part of the display device 1 illustrated in FIG. 1, the part being provided with a space SP1. In FIG. 1, a side on which a front panel 50 is provided is referred to as a front surface side, and a side on which an image capturing device 10 is provided is referred to as a back surface side.

As illustrated in FIG. 1, the display device 1 includes the image capturing device 10, a backlight 20, a liquid crystal panel 30, an adhesive layer 40, the front panel 50, a print layer PL, and a light blocking tape ST. As illustrated in FIG. 2, according to the display device 1, (i) the space SP1 is formed in a display screen D1 and (ii) an image capturing section 12 (the image capturing device 10) is provided in the space SP1. The display device 1 thus displays an image. The front panel 50 is made of a light transmissive material such as glass or a resin and forms an outermost surface of the display device 1.

The image capturing device 10 includes a housing 11 and the image capturing section 12. The housing 11 houses therein the image capturing section 12. The housing 11 and the liquid crystal panel 30 are provided on opposite sides of the backlight 20. The housing 11 has an opening on a front panel 50 side so that light from an outside of the display device 1 enters the image capturing section 12 via the opening.

With the arrangement, in a case where the display device 1 is viewed from the front panel 50 side, it is possible to make an outer circumferential part of the housing 11 of the image capturing device 10 invisible by the backlight 20. The image capturing section 12 is configured to (i) receive, through the space SP1, light from the outside of the display device 1 and (ii) generate image data in accordance with a result obtained by capturing an image which is obtained by thus receiving the light.

The backlight 20 irradiates the liquid crystal panel 30 with light which is necessary for a display of an image and has wavelengths including wavelengths of light having respective three colors of red, green, and blue. The backlight 20 is, for example, a white light source such as a light source including a plurality of white light emitting diodes (LEDs). The image capturing device 10 is provided on a rear surface side of the backlight 20. The liquid crystal panel 30 is provided on a front surface side of the backlight 20.

The light blocking tape ST is provided so as to be sandwiched between the backlight 20 and a first polarizing plate 31. Specifically, the light blocking tape ST is provided, along a space SP1 side edge part of the backlight 20, so as to cover the space SP1 side edge part of the backlight 20. This allows the light blocking tape ST to block light which exits through the space SP1 side edge part of the backlight 20. It is therefore possible to prevent a deterioration in image quality of the display device 1.

The liquid crystal panel 30 is provided on the backlight 20 so as to be located between the backlight 20 and the adhesive layer 40. The liquid crystal panel 30 includes a first polarizing plate 31, a liquid crystal panel glass part 32, and a second polarizing plate 33. The first polarizing plate 31 and the second polarizing plate 33 are each provided so as to polarize light emitted from the backlight 20. The first polarizing plate 31 is provided on the front surface of the backlight 20, and the second polarizing plate 33 is provided on a back surface of the adhesive layer 40. That is, the second polarizing plate 33 and the first polarizing plate 31 are provided on opposite sides of the liquid crystal panel glass part 32. The first polarizing plate 31 is provided between the backlight 20 and a TFT (thin film transistor) side glass substrate 32T. The second polarizing plate 33 is provided between a color filter side glass substrate 32F and the adhesive layer 40.

The liquid crystal panel glass part 32 is provided so as to be sandwiched between the first polarizing plate 31 and the second polarizing plate 33. The liquid crystal panel glass part 32 includes the TFT side glass substrate 32T, a liquid crystal molecule layer 32C, a black mask layer BM, and the color filter side glass substrate 32F.

On the TFT side glass substrate 32T, a plurality of TFTs are provided in a matrix pattern. The TFT side glass substrate 32T is provided between the first polarizing plate 31 and the liquid crystal molecule layer 32C. Note that the TFT side glass substrate 32T includes a light transmissive region, because the TFT side glass substrate 321 is used for the display screen of the display device 1.

The liquid crystal molecule layer 32C includes an array of liquid crystal molecules which range from one side of a cell gap to the other. The liquid crystal molecule layer 32C is provided so as to be located between the TFT side glass substrate 32T and the color filter side glass substrate 32F. The liquid crystal molecule layer 32C can be configured to include a region 32CR in which a pixel electrode E1 and a counter electrode E2 are not provided, the pixel electrode E1 and the counter electrode E2 each for changing a direction in which the liquid crystal molecules are aligned. Note that FIG. 1 illustrates the pixel electrode E1, which is supposed to be provided for each pixel, in a continuous shape for convenience. That is, the pixel electrode E1 and the counter electrode E2 can be configured to be provided in a region of the liquid crystal molecule layer 32C, which region is different from the region 32CR.

The pixel electrode E1 is provided on the TFT side glass substrate 32T, and the counter electrode E2 is provided on the color filter side glass substrate 32F. The liquid crystal molecules are provided between the counter electrode E2 and the pixel electrode E1. Note that (i) the counter electrode E2 is located closer to the front surface side and (ii) the pixel electrode E1 is located closer to the back surface side. The pixel electrode E1 and the counter electrode E2 are each a transparent electrode.

The region 32CR is a region of the liquid crystal molecule layer 32C, which region is located within the range R1 of angle of view of the image capturing device 10. Note that, as illustrated in FIG. 1, the region 32CR can be a region of the liquid crystal molecule layer 32C, which region is larger than the region, which is located within the range R1 of angle of view. The liquid crystal molecules can also be provided in the region 32CR. Alternatively, no liquid crystal molecules can be provided in the region 32CR. That is, only glass can be provided in the region 32CR.

In view of the above, the pixel electrode E1 and the counter electrode E2, each for changing a direction in which the liquid crystal molecules of the liquid crystal molecule layer 32C are aligned, are provided so as to avoid a part located within the range R1 of angle of view of the image capturing device 10. With the arrangement, without the need to provide any space in the liquid crystal panel glass part 32, it is possible for light from the outside of the display device 1 to enter the image capturing device 10 without being attenuated. Since no space consequently needs to be provided in the liquid crystal panel glass part 32, the display device 1 can be manufactured at lower cost.

The black mask layer BM is provided so as to be sandwiched between the TFT side glass substrate 32T and the liquid crystal molecule layer 32C. The black mask layer BM is provided, along (i) the space SP1 side edge part of the backlight 20 and (ii) a space SP1 side edge part of the first polarizing plate 31, so as to cover the respective space SP1 side edge parts of the backlight 20 and the first polarizing plate 31. The black mask layer BM is provided to make invisible (i) the space SP1 side edge part of the backlight 20 and (ii) the space SP1 side edge part of the first polarizing plate 31, in a case where the display device 1 is viewed from the front panel 50 side. Furthermore, the black mask layer BM is provided to block light which exits through the space SP1 side edge part of the backlight 20.

With the arrangement, (i) the space SP1 side edge part of the backlight 20 and (ii) the space SP1 side edge part of the first polarizing plate 31 are made invisible by the black mask layer BM, in a case where the display device 1 is viewed from the front panel 50 side. This allows the display device 1 to be more excellent in design. The color filter side glass substrate 32F is provided so as to be sandwiched between the liquid crystal molecule layer 32C and the second polarizing plate 33.

Furthermore, the black mask layer BM is provided so as to cover electric wires T1 and electric wires T2 (see FIG. 2). With the arrangement, the electric wires T1 and the electric wires T2 are made invisible by the black mask layer BM, in a case where the display device 1 is viewed from the display screen D1 side. The display screen D1 has an outer edge side which is provided with the space SP1. The image capturing section 12 is provided in the space SP1.

The electric wires T1 are provided on the TFT side glass substrate 32T while extending along (i) the outer edge side of the display screen D1 and (ii) the space SP1. The electric wires T2 are provided to be in parallel with the outer edge side of the display screen D1 so as to be closer to a center of the display screen D1 than the electric wires T1. The electric wires T2 are provided on the TFT side glass substrate 32T.

The adhesive layer 40 can be, for example, an optical transparent adhesive (optical clear adhesive (OCA)). With the arrangement, light emitted from the backlight 20 passes through the adhesive layer 40, and then exits through the front panel 50. The adhesive layer 40 is provided between the second polarizing plate 33 and the front panel 50. That is, the adhesive layer 40 and the liquid crystal panel glass part 32 are provided on opposite sides of the second polarizing plate 33. The adhesive layer 40 adheres the second polarizing plate 33 and the front panel 50 to each other. The front panel 50 is provided on a front surface of the adhesive layer 40.

The print layer PL is partially provided between the adhesive layer 40 and the front panel 50. That is, the print layer PL and the second polarizing plate 33 are provided on opposite sides of the adhesive layer 40. The print layer PL is provided, along (i) a space SP1 side edge part of the second polarizing plate 33 and (ii) a space SP1 side edge part of the adhesive layer 40, so as to cover the respective space SP1 side edge parts of the second polarizing plate 33 and the adhesive layer 40. The print layer PL is provided to make invisible (i) the space SP1 side edge part of the second polarizing plate 33 and (ii) the space SPI side edge part of the adhesive layer 40, in a case where the display device 1 is viewed from the front panel 50 side.

With the arrangement, (i) the space SP1 side edge part of the second polarizing plate 33 and (ii) space SP1 side edge part of the adhesive layer 40 are made invisible by the print layer PL, in a case where the display device 1 is viewed from the front panel 50 side. This allows the display device 1 to be more excellent in design.

The space SP1 for light transmission is formed in each of the backlight: 20, the first polarizing plate 31, the second polarizing plate 33, and the adhesive layer 40 so that light from the outside of the display device 1 enters the image capturing device 10. Thus, the backlight 20, the first polarizing plate 31, the second polarizing plate 33, and the adhesive layer 40 are not located in the range R1 of angle of view of the image capturing device 10.

The adhesive layer 40 is soft. In a case where no space SP1 is formed in the adhesive layer 40, a difference in level therefore occurs between the adhesive layer 40 and the second polarizing plate 33. The difference in level between the adhesive layer 40 and the second polarizing plate 33 causes the display device 1 to have a lower image quality. In view of the circumstances, the space SP1 is preferably formed in the adhesive layer 40 so that no difference in level occurs between the adhesive layer 40 and the second polarizing plate 33.

As described earlier, the image capturing device 10 and the liquid crystal panel 30 are provided on opposite sides of the backlight 20. Furthermore, the space SP1 for light transmission is formed in each of the first polarizing plate 31, the second polarizing plate 33, and the backlight 20. With the arrangement, a part of the image capturing device 10, which part is outer than the image capturing section 12, is made invisible by the backlight 20, in a case where (i) image capturing device 10 includes the image capturing section 12 and (ii) the display device 1 is viewed from the front panel 50 side.

Thus, for example, in a case where the print layer PL is provided so as to (i) face in a direction in which the liquid crystal panel 30 and the backlight 20 are provided in this order and (ii) cover an outer circumferential part of the space SPI, it is possible to make the print layer PL smaller in size as much as a part of the image capturing device 10 is made invisible by the backlight 20. This makes it possible to (i) make the display device 1 more excellent in design while maintaining performance of the image capturing device 10 and (ii) increase a display region of the display device 1 as much as the print layer PL has been made smaller in size.

### Embodiment 2

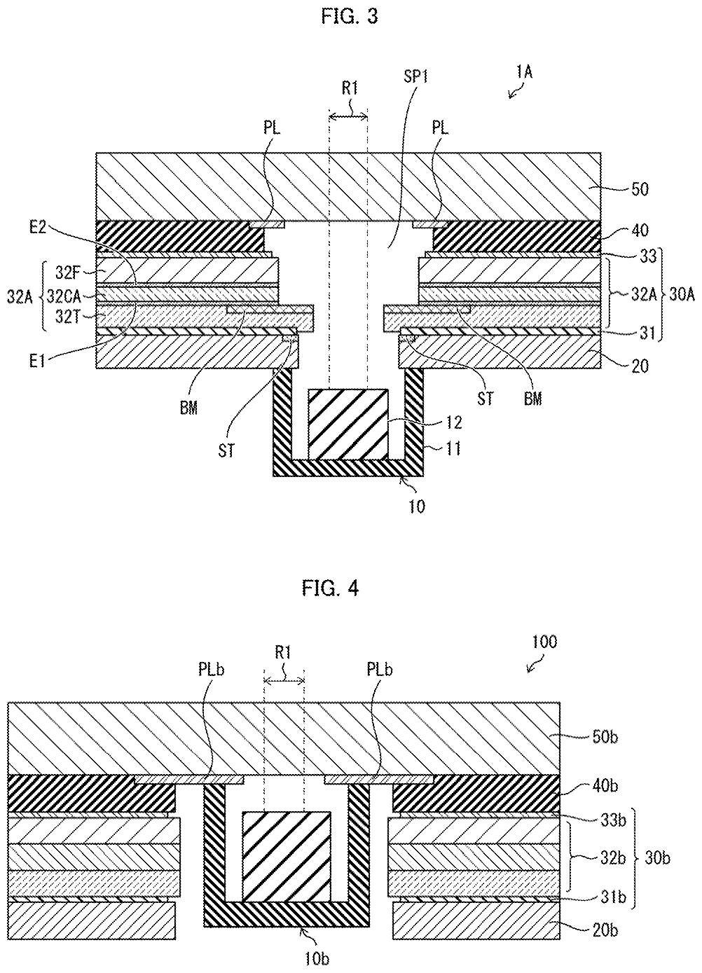

FIG. 3 is a cross-sectional view illustrating an arrangement of a cross section of a display device 1A in accordance with Embodiment 2 of the present invention. Note that, for convenience, members having functions identical to those of the respective members described in Embodiment 1 are given respective identical reference signs, and a description of those members is omitted here.

As illustrated in FIG. 3, the display device 1A differs from the display device 1 in that the display device 1A includes a liquid crystal panel 30A, instead of the liquid crystal panel 30. The liquid crystal panel 30A includes a first polarizing plate 31, a liquid crystal panel glass part 32A, and a second polarizing plate 33. The liquid crystal panel glass part 32A includes a TFT side glass substrate 32T, a liquid crystal molecule layer 32CA, and a color filter side glass substrate 32F.

The liquid crystal molecule layer 32CA differs from the liquid crystal molecule layer 32C in that the liquid crystal molecule layer 32CA includes no region 32CR and is provided with a space SP1. That is, the liquid crystal molecule layer 32CA is provided with the space SP1, instead of including no region 32CR. The liquid crystal molecule layer 32CA, which is provided with the space SP1, is not located in a range R1 of angle of view of an image capturing device 10. The arrangement makes it possible for light from an outside of the display device 1A to enter the image capturing device 10 without being attenuated.

The TFT side glass substrate 32T and the color filter side glass substrate 32F can he provided with the space SP1 as illustrated in FIG. 3. Note, however, that the TFT side glass substrate 32T and the color filter side glass substrate 32F can alternatively be provided with no space SP1. That is, the TFT side glass substrate 32T and the color filter side glass substrate 32F can be located in the range R1 of angle of view.

Aspects of the present invention can also be expressed as follows:

A display device in accordance with a first aspect of the present invention includes: a backlight; and a liquid crystal panel provided on the backlight, the liquid crystal panel including a first polarizing plate, a second polarizing plate, and a liquid crystal panel glass part which is provided so as to be sandwiched between the first polarizing plate and the second polarizing plate, a space for light transmission being formed in each of the first polarizing plate, the second polarizing plate, and the backlight so that light from an outside of the display device enters an image capturing device, the liquid crystal panel and the image capturing device being provided on opposite sides of the backlight.

In a second aspect of the present invention, a display device can be arranged such that, in the first aspect of the present invention, the liquid crystal panel glass part includes an electrode for changing a direction in which liquid crystal molecules of the liquid crystal panel glass part are aligned, the electrode being provided so as to avoid a part located within a range of angle of view of the image capturing device.

In a third aspect of the present invention, a display device can be arranged such that: in the first or second aspect of the present invention, the first polarizing plate is provided so as to be located between the liquid crystal panel glass part and the backlight; and the second polarizing plate arid the first polarizing plate are provided on opposite sides of the liquid crystal panel glass part, the display device further including: an adhesive layer, the adhesive layer and the liquid crystal panel glass part being provided on opposite sides of the second polarizing plate; and a print layer, the print layer and the second polarizing plate being provided on opposite sides of the adhesive layer, the print layer being provided, along (i) a space side edge part of the second polarizing plate and (ii) a space side edge part of the adhesive layer, so as to cover the respective space side edge parts of the second polarizing plate and the adhesive layer.

In a fourth aspect of the present invention, a display device can be arranged such that: in the third aspect of the present invention, the liquid crystal panel glass part includes a TFT (thin film transistor) side glass substrate, a liquid crystal molecule layer, and a black mask layer which is provided so as to be sandwiched between the TFT side glass substrate and the liquid crystal molecule layer; and the black mask layer is provided, along (i) a space side edge part of the backlight and (ii) a space side edge part of the first polarizing plate, so as to cover the respective space side edge parts of the backlight: and the first polarizing plate.

In a fifth aspect of the present invention, a display device can be arranged to, in the third or fourth aspect of the present invention, further include: a light blocking tape provided so as to be sandwiched between the backlight and the first polarizing plate, the light blocking tape being provided, along the space side edge part of the backlight, so as to cover the space side edge part of the backlight.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1A Display device

10 Image capturing device

11 Housing

12 image capturing section

20 Backlight

30, 30A Liquid crystal panel

31 First polarizing plate

32, 32A Liquid crystal panel glass part

32C, 32CA Liquid crystal molecule layer

32CR Region

32F Color filter side glass substrate

32T TFT side glass substrate

33 Second polarizing plate

40 Adhesive layer

50 Front panel

BM Black mask layer

D1 Display screen

E1 Pixel electrode

E2 Counter electrode

PL Print layer

R1 Range of angle of view

SP1 Space

ST Light blocking tape

T1, T2 Electric wire

1. A display device comprising:
a backlight; and
a liquid crystal panel provided on the backlight, the liquid crystal panel including a first polarizing plate, a second polarizing plate, and a liquid crystal panel glass part which is provided so as to be sandwiched between the first polarizing plate and the second polarizing plate,
a space for light transmission being formed in each of the first polarizing plate, the second polarizing plate, and the backlight so that light from an outside of the display device enters an image capturing device, the liquid crystal panel and the image capturing device being provided on opposite: sides of the backlight.

2. The display device as set forth in claim 1, wherein the liquid crystal panel glass part includes an electrode for changing a direction in which liquid crystal molecules of the liquid crystal panel glass part are aligned, the electrode being provided so as to avoid a part located within a range of angle of view of the image capturing device.

3. The display device as set forth in claim 1, wherein:
the first polarizing plate is provided so as to be located between the liquid crystal panel glass part and the backlight; and
the second polarizing plate and the first polarizing plate are provided on opposite sides of the liquid crystal panel glass part,
said display device further comprising:
an adhesive layer, the adhesive layer arid the liquid crystal panel glass part being provided on opposite sides of the second polarizing plate; and
a print layer, the print layer and the second polarizing plate being provided on opposite sides of the adhesive layer,
the print layer being provided, along (i) a space side edge part of the second polarizing plate and (ii) a space side edge part of the adhesive layer, so as to cover the respective space side edge parts of the second polarizing plate and the adhesive layer.

4. The display device as set forth in claim 3, wherein:
the liquid crystal panel glass part includes a TFT (thin film transistor) side glass substrate, a liquid crystal molecule layer, and a black mask layer which is provided so as to be sandwiched between the TFT side glass substrate and the liquid crystal molecule layer; and
the black mask layer is provided, along (i) a space side edge part of the backlight and (ii) a space side edge part of the first polarizing plate, so as to cover the respective space side edge parts of the backlight and the first polarizing plate.

5. A display device as set forth in claim 3, further comprising:
a light blocking tape provided so as to be sandwiched between the backlight and the first polarizing plate,
the light blocking tape being provided, along the space side edge part of the backlight, so as to cover the space side edge part of the backlight.
